(19) United States
(12) Patent Application Publication
(10) Pub. No.: US 2015/0317574 A1
(43) Pub. Date: Nov. 5, 2015

(54) COMMUNAL ORGANIZATION CHART

(71) Applicant: LinkedIn Corporation, Mountain View, CA (US)

(72) Inventors: Mark Hull, San Jose, CA (US); Anand Kishore Bollini, Palo Alto, CA (US); Andrew P. Hill, San Francisco, CA (US); Roland Schemers, Woodside, CA (US); Christopher J. Fong, San Mateo, CA (US); Dhananjay Ragade, Mountain View, CA (US); James Richards, San Jose, CA (US); Wing Lun Ting, San Francisco, CA (US); Parag Naresh Shah, Santa Clara, CA (US)

(73) Assignee: LinkedIn Corporation, Mountain View, CA (US)

(21) Appl. No.: 14/266,737

(22) Filed: Apr. 30, 2014

(51) Int. Cl. G06Q 10/06

(52) U.S. Cl. CPC G06Q 10/067

(57) ABSTRACT

A system, computer-readable storage medium, and computer-implemented method for maintaining an accurate organization chart, are presented. The method may include accessing organization chart data defining a hierarchy of an organization comprising a group of users. At least one user of the group of users may be prompted to provide verification information pertaining to the accuracy of a portion of the organization chart data. Upon receiving the verification information from the at least one user, the method may include updating the organization chart data in accordance with the verification information.

### TECHNICAL FIELD

This patent document pertains generally to data processing systems, and more particularly, but not by way of limitation, to organization chart generation and maintenance.

### BACKGROUND

Organization charts are diagrams used to show the structure of an organization (e.g., a company) including the relations and the positions or the responsibilities of each of its members. For example, organization charts typically illustrate the relationships between managing directors and directors, managers and subordinate employees, and executive officers and various departments within an organization. Personnel changes within an organization, such as employees leaving the organization, new employees joining the organization, and employees' ever changing positions and responsibilities (e.g., due to promotions), are difficult to track and can quickly lead to the information in an organization chart becoming stale and outdated. Further, for larger organizations with several members it is difficult to maintain an accurate and up-to-date organization chart because the structure may be too complex and constantly evolving.

### BRIEF DESCRIPTION OF DRAWINGS

Various ones of the appended drawings merely illustrate example embodiments of the present invention and cannot be considered as limiting its scope.

FIG. 1 is a block diagram illustrating various functional components of a social network service, according to an example embodiment.

FIG. 2 is a block diagram illustrating various functional modules that form an organization chart maintenance application, which is provided as part of the social network service, according to an example embodiment.

FIG. 3A is a block diagram illustrating an organization chart, according to an example embodiment.

FIG. 3B is an interface diagram illustrating a window prompting a user for organization chart verification information, according to an example embodiment.

FIG. 3C is an interface diagram illustrating another window prompting the user for organization chart verification information, according to an example embodiment.

FIG. 3D is an interface diagram illustrating yet another window prompting the user for organization chart verification information, according to an example embodiment.

FIG. 3E is an interface diagram illustrating still another window prompting the user for organization chart verification information, according to an example embodiment.

FIG. 3F is a block diagram illustrating an updated organization chart based on the verification information received from the user, according to an example embodiment.

FIG. 4 is a flowchart illustrating a method for generating an organization chart based on social data, according to an example embodiment.

FIG. 5 is a flowchart illustrating a method for updating organization chart data based on information received from a user who is included in the organization chart, according to an example embodiment.

FIG. 6 is a flowchart illustrating a method for updating organization chart data based on information received from a group of users included in the organization chart, according to an example embodiment.

FIG. 7 is a flowchart illustrating a method for tracking accuracy of organization chart data, according to an example embodiment.

FIG. 8 is a block diagram of machine in the example form of a computer system within which a set instructions may be executed for causing machine to perform any one or more of the methodologies discussed herein.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

As used herein, an “organization chart” refers to a graph, diagram or other illustration that defines the hierarchy of an organization (e.g., a company) comprising a group of individuals (e.g., employees). More particularly, the organization chart describes the structure of the organization and the relationships and relative ranks of its members.

Consistent with some embodiments, at least a portion of the members of an organization represented by an organization chart may be users of a social network service. The social network may track and record detailed information about its users as well as various relationships and interactions of such users. In this manner, the social network service is uniquely positioned to both generate and update organization charts for its users. In this manner, aspects of the present disclose may provide consistently accurate and up-to-date organization charts.

Aspects of the present disclosure include a system and methods for generating an accurate organization chart based on social data about the members of the organization. In some embodiments, such a method may include identifying a group of users who each belong to a common organization as defined by a social graph maintained by a social network service. Social data about each of the users, including relationships of the group of users, is then accessed. From the social data of each member of the group of users, the method may determine the organization chart for the organization. Data representative of the organization chart may then be stored for later retrieval.

Aspects of the present disclosure include a system and methods for maintaining an accurate organization chart. In some embodiments, such a method may include accessing organization chart data representing an organization chart. The organization chart may be inferred in accordance with the method discussed above, or may be generated using traditional processes. The method may further include selecting a portion of the organization chart to be verified by a selected user or group of users. The selected user or group of users may then be asked to verify the information represented by the portion of the organization chart data, or provide accurate information, if necessary. The method may further include updating the organization chart data based on the information received from the selected user or group of users.

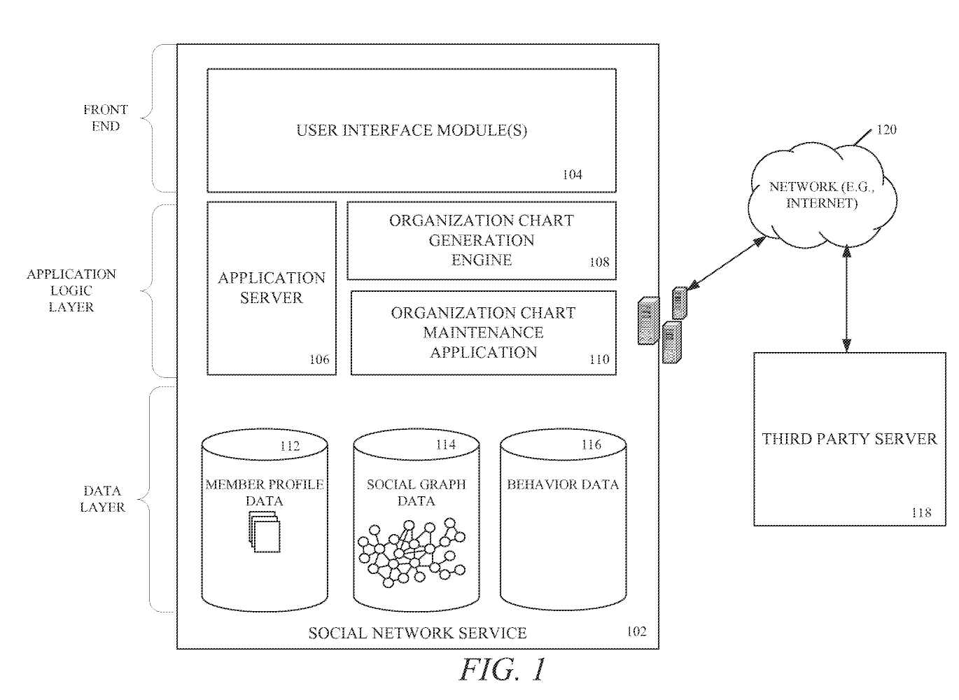

FIG. 1 is a block diagram illustrating various functional components of a social network service 102. As shown in FIG. 1, the social network service 102 is generally based on a three-tiered architecture, consisting of a front-end layer, an application logic layer, and a data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be supported by a social network service to facilitate additional functionality that is not specifically described herein. Furthermore, the various functional modules and engines depicted in FIG. 1 may reside on a single server computer, or may be distributed across several server computers in various arrangements. Moreover, although the social network service is depicted in FIG. 1 as a three-tiered architecture, the inventive subject matter is by no means limited to such architecture.

As shown in FIG. 1, the front end consists of one or more user interface modules (e.g., a web server) 104, which receive requests from various client-computing devices, and communicate appropriate responses to the requesting client devices. For example, the user interface module(s) 104 may receive requests from client devices in the form of Hypertext Transfer Protocol (HTTP) requests, or other web-based, application programming interface (API) requests. The client devices (not shown) may be executing conventional web browser applications, or applications that have been developed for a specific platform to include any of a wide variety of mobile devices and operating systems. The user interface module(s) 104 may also be configured to provide graphical user interface elements to prompt users for information, and to receive such information from the users.

As shown, the application logic layer includes an application server 106, which, in conjunction with the user interface module 104, generates various user interfaces web pages) with data retrieved from various data sources in the data layer. In some embodiments, individual application servers 106 are used to implement the functionality associated with various services and features of the social network service 102. For instance, the ability of an organization to establish a presence in the social graph of the social network service 102, including the ability to establish a customized web page on behalf of an individual or organization, and to publish messages or status updates on behalf of an individual or organization, may be services implemented in independent application servers 106. Similarly, a variety of other applications or services that are made available to members of the social network service 102 may be embodied in their own application servers 106.

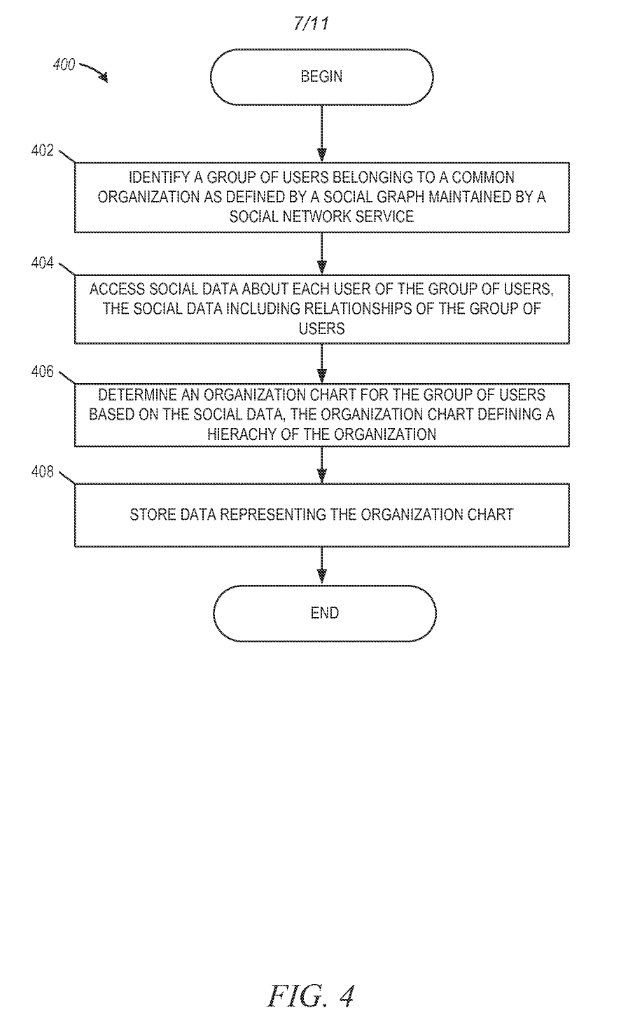

As illustrated in FIG. 1, the application layer also includes an organization chart generation engine 108 to generate organization charts for organizations that have established a presence in the social graph of the social network service 102. An example process by which the organization chart generation engine 108 may generate an organization chart is presented below in reference to FIG. 4. Another example process by which the organization chart generation engine 108 may generate an organization chart is described in U.S. patent application Ser. No. 13/756,142, entitled “TECHNIQUES FOR INFERRING AN ORGANIZATIONAL HIERARCHY FROM A SOCIAL GRAPH.”

Data representative of organization charts (hereinafter referred to as “organization chart data”) may be stored in a database of the social network service 102, examples of which are described below in reference to the data layer of the social network service 102. The organization chart data may also include one or more accuracy indicators (e.g., flags) that provide an indicator of the accuracy of the information in the organization charts. Consistent with some embodiments, the accuracy indicators may provide a binary indicator of accuracy whereby portions of organization chart data may be described as either “accurate” or “inaccurate.” Consistent with some embodiments, the accuracy indicators may provide a granular indicator of accuracy such as a percentage indicating likelihood that a portion of the organization chart data is accurate.

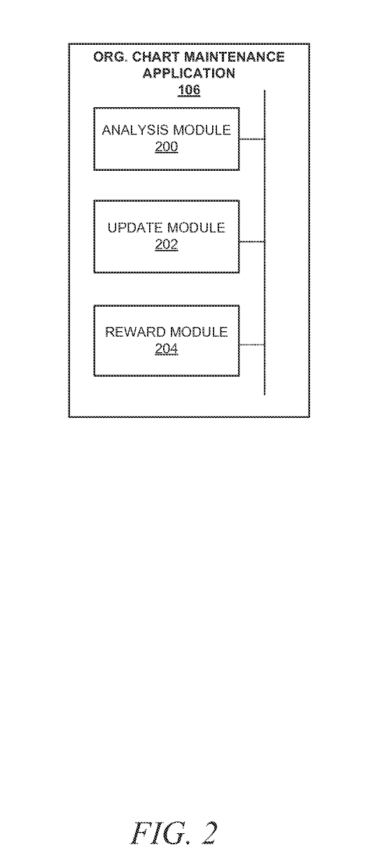

Consistent with some embodiments, at least a portion of the members of an organization represented in an organization chart may be users of the social network service 102. As such, the social network service 102 may leverage information about and received from users who are members of an organization to update and maintain an accurate organization chart for the organization. To this end, the social network service 102 includes an organization chart maintenance application 110 that may update and maintain accurate organization charts based on information received from users of the social network service 102. Further details of the modules comprising the organization chart maintenance application 110 are presented below in reference to FIG. 2. Although the organization chart maintenance application 110 is illustrated in FIG. 1 as being integrated and operating in conjunction with the social network service 102, it shall be appreciated that with various alternative embodiments, the organization chart maintenance application 110 may be implemented within its own application server module such that it operates as a stand-alone application.

As shown in FIG. 1, the data layer includes several databases, including a member profile database 112 for storing general information contained on a social network profile, including general contact information, employer information, and educational institution information, as well as information concerning various online or offline groups. Member profile database 112 may contain information for member profiles for only a single social network profile or for profiles on several different social networks. As used herein, “member” or “user” refers to an individual (e.g., a person), an entity, a business (e.g., a company), an organization, a group of people, a bot, or any combination thereof that utilizes the services provided by the social networking service 102.

Consistent with some embodiments, when a person initially registers to become a member of a social network service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored, for example, in the member profile database 112. Similarly, when a representative of an organization initially registers the organization with the social network service, the representative may be prompted to provide certain information about the organization. This information may be stored, for example, in the member profile database 112.

Member profile database 112 may also contain contact information such as lists of contacts, previous employers, interests, organizational affiliations, and personal and professional addresses, phone numbers and websites. In some embodiments, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company, in some embodiments, importing or otherwise accessing data from one or more externally hosted data sources may enhance profile data for both members and organizations. For instance, with companies in particular, financial data may be imported from one or more external data sources, and made part of a company's profile.

As shown in FIG. 1, the data layer also includes social graph database 114, which is a particular type of database that uses graph structures with nodes, edges, and properties to represent and store data. Of course, in various alternative embodiments, any number of other entities might be included in the social graph, and as such, various other databases may be used to store data corresponding with other entities.

Once registered, a member of social network service 102 may invite other members, or be invited by other members, to connect via the social network service 102. A “connection” may require a bilateral agreement by the members, such that both members acknowledge the establishment of the connection. Similarly, a member may elect to “follow” another member. In contrast to establishing a “connection”, the concept of “following” another member typically is a unilateral operation, and at least in some embodiments, does not call for acknowledgement or approval by the member that is being followed. When one member follows another, the member who is following may receive automatic notifications about various activities undertaken by the member being followed. In addition to following another member, a user may elect to follow a company, atopic, a conversation, or some other entity. Similarly, when a member follows an organization, the member becomes eligible to receive messages or status updates published on behalf of the organization. For instance, messages or status updates published on behalf of an organization that a member is following will appear in the member's personalized data feed. For purposes of the present disclosure, the term “connection” shall include both the bilateral agreement by both members and the unilateral operation of “following”. The various associations and relationships that the members establish with other members, or with other entities and objects, are stored and maintained within the social graph database 114.

The social network service 102 may also provide abroad range of other applications and services that allow members the opportunity to share and receive information, often customized or personalized to the interests of the member. For example, the social network service 102 may include a photo sharing application that allows members to upload and share photos with other members. As such, at least in some embodiments, a photograph may be a property or entity included within a social graph. Members of the social network service 102 may be able to self-organize into groups, or interest groups, organized around a subject matter or topic of interest. Accordingly, the data for a group may be stored in social graph database 114. When a member joins a group, his or her membership in the group will be reflected in the social graph data stored in the social graph database 114. In some embodiments, members may subscribe to or join groups affiliated with one or more companies. For instance, in some embodiments, members of the social network service 102 may indicate an affiliation with a company at which they are employed, such that news and events pertaining to the company are automatically communicated to the members. In some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modeled with the social graph data of the social graph database 114.

As a member interacts with various applications, services and content made available via the social network service 102, the member's behavior (e.g., content viewed, links or buttons selected, messages responded to, etc.) may be tracked, and information concerning the member's activities and behavior may be logged or stored, for example, as indicated in FIG. 1 by behavior database 116. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus more likely to be receptive to recruiting efforts. For purposes of this disclosure, the term “social data” may be used to collectively refer to the data stored in databases 112, 114 and 116.

Consistent with some embodiments, the social network service 102 may provide an application programming interface (API) module via which third-party applications hosted by a third party server 118 may access various services and data provided by the social network service 102. For example, using an API, a third-party application may provide a user interface and logic that enables an authorized representative of an organization to publish messages from a third-party application to various data feeds maintained by the social network service 102. Such third-party applications may be browser-based applications, or may be operating system-specific. In particular, some third-party applications may reside and execute on one or more mobile devices (e.g., phone, or tablet computing devices) having a mobile operating system.

The third party server 118 may be coupled to a network 120, for example, via wired or wireless interfaces. The network 120 may be a LAN, a WAN, the Internet, or another packet-switched data network. Accordingly, a variety of different configurations are expressly contemplated.

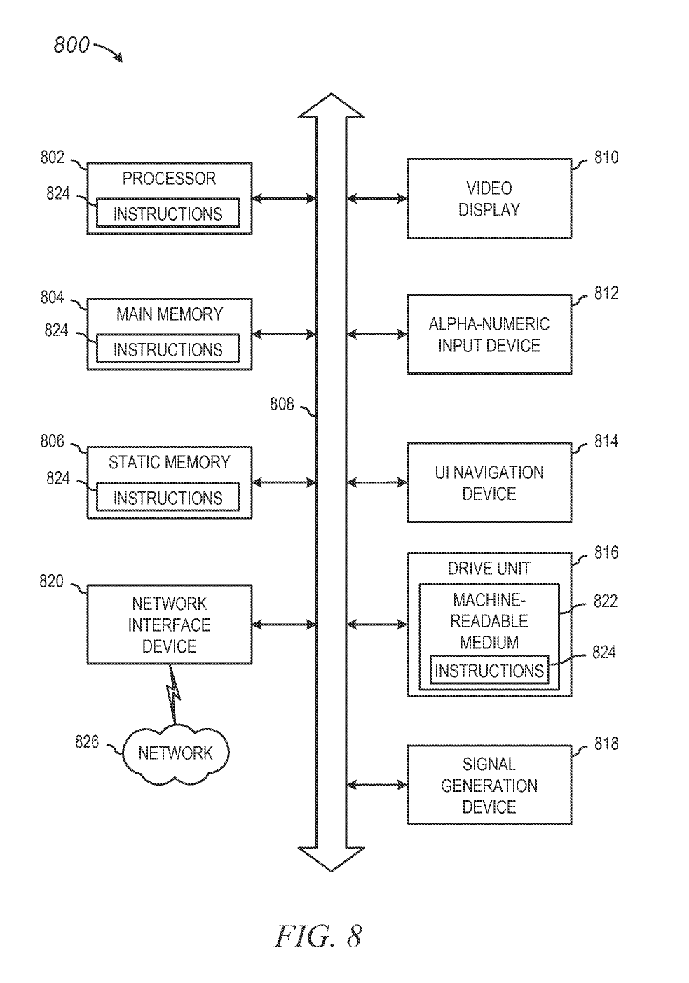

FIG. 2 is a block diagram illustrating various functional modules that form the organization chart maintenance application 110, according to an example embodiment. In particular, the organization chart maintenance application 110, as illustrated in FIG. 2, includes an analysis module 200, an update module 202, and a reward module 204, all configured to communicate (e.g., access and share common data) with each other (e.g., via a bus, a shared memory, a network, or a switch). The modules 200, 202 and 204 may furthermore access one or more of the databases 112, 114 and 116 illustrated in FIG. 1. Any of these modules may be implemented using hardware, as described below with respect to FIG. 8. Moreover, any two or more of these modules may be combined into a single module, and the functions described herein for a single module may be subdivided among multiple modules. It shall be appreciated that although the various functional components of the organization chart maintenance application 110 are discussed in the singular sense, multiple instances of one of more of the various functional components may be employed.

The analysis module 200 may be a hardware implemented module, software executed by general purpose or special purpose hardware, or instructions stored on a computer readable medium that operate to analyse organization chart data to select portions of the organization chart data for verification by users of the social network service 102. The portions of the organization chart data selected by the analysis module 200 may be based on one or more accuracy indicators stored with the organization chart data. The analysis module 200 may also select certain users from which verification information pertaining to the accuracy of an organization chart is to be requested. The analysis module 200 may select such users based on an association with the organization chart data. For example, the analysis module 200 may select a certain user to prompt to provide verification information for a portion of organization chart data based on the portion of organization chart data representing supervisors or subordinates of the user.

The analysis module 200 may further be configured to analyse other information (e.g., social data) from various other sources (e.g., databases 112, 114 and 116) to determine the accuracy of the organization chart data. For example, the analysis module 200 may make determinations of the accuracy of organization chart data based on changes to member profile data, contradictory information about organization chart data received from users, or the staleness of data (e.g., an amount of time passed since data was last updated). The analysis module 200 may work in conjunction with the update module 202 to update the accuracy indicators to reflect such determinations of accuracy.

The update module 202 may be a hardware implemented module, software executed by general purpose or special purpose hardware, or instructions stored on a computer readable medium that is operative to update organization chart data. In addition to updating the accuracy indicators of the organization chart data as discussed above, the update module 202 may also update the portion of organization chart data representative of the organization chart itself. Consistent with some embodiments, the update module 202 may update the organization chart data based on information received from users of the social network service 102 via graphical user interfaces provided by the user interface module(s) 104. In this manner, the update module 202 may modify organization charts (e.g., represented by the organization chart data) to ensure that the organization charts are accurate and up to date.

The reward module 204 may be a hardware implemented module, software executed by general purpose or special purpose hardware, or instructions stored on a computer readable medium that is operative to provide users with rewards in response to the users responding to a request for verification information. Rewards may be provided immediately or on a routine basis (e.g., at the end of each day). In some embodiments, rewards or the value of rewards provided to a user may depend on the verification information provided by the user matching the verification information provided by a predetermined number (e.g., a majority) of other users from whom verification information has also been requested. Rewards may be accumulated by users and in some embodiments, may be redeemed for games, goods, services or other offerings of the social network service 102. In some embodiments, the analysis module 200 may analyze the amount of rewards a user has accumulated in selecting the user to request further verification information.

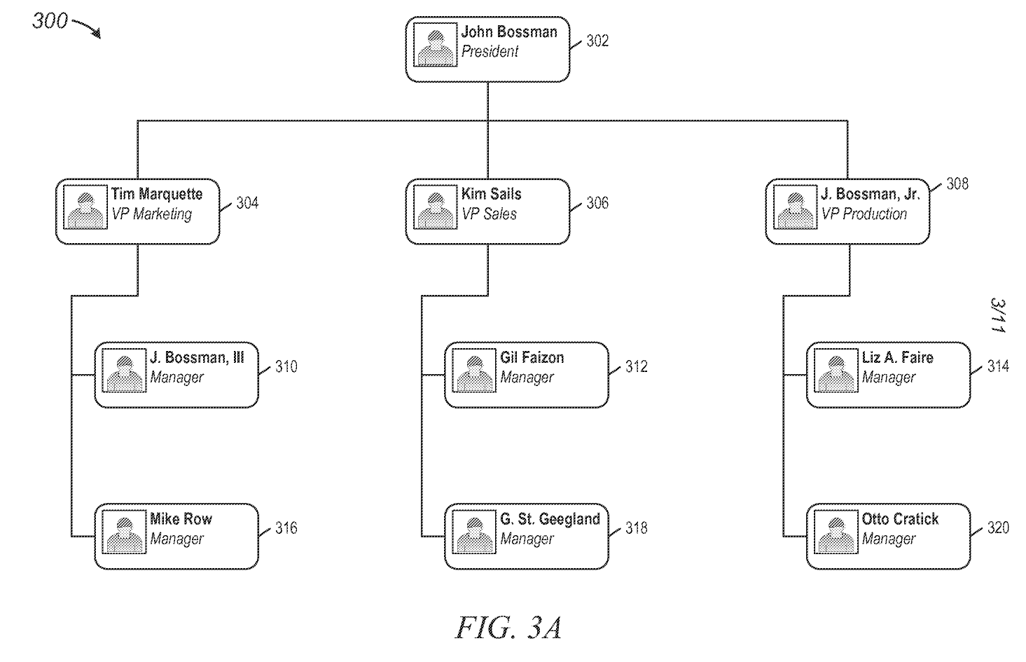

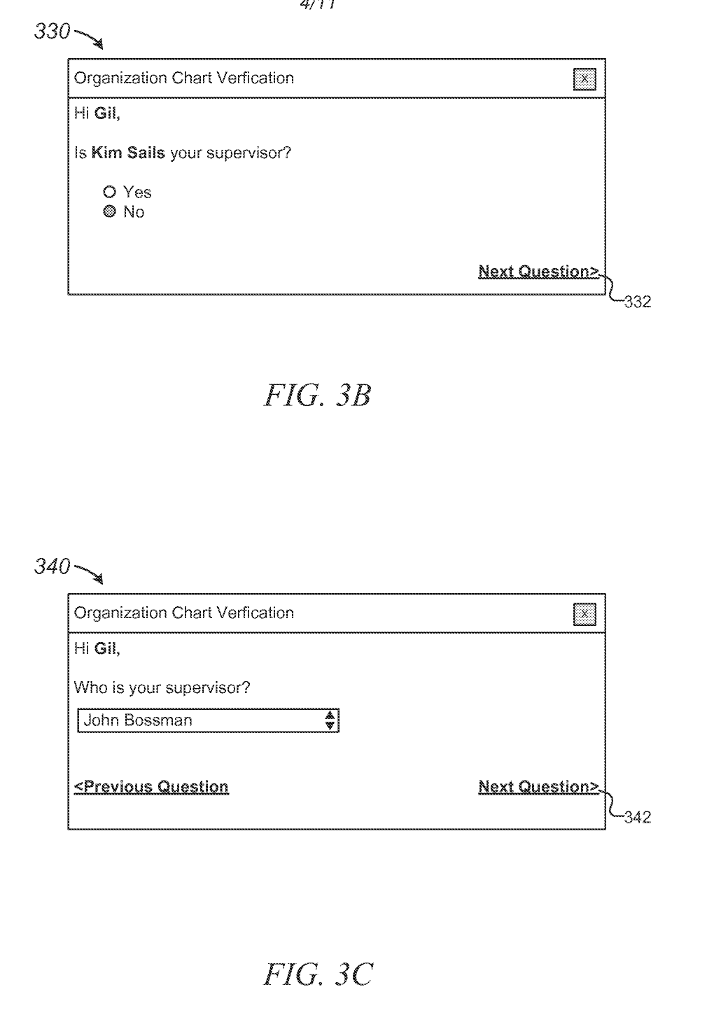

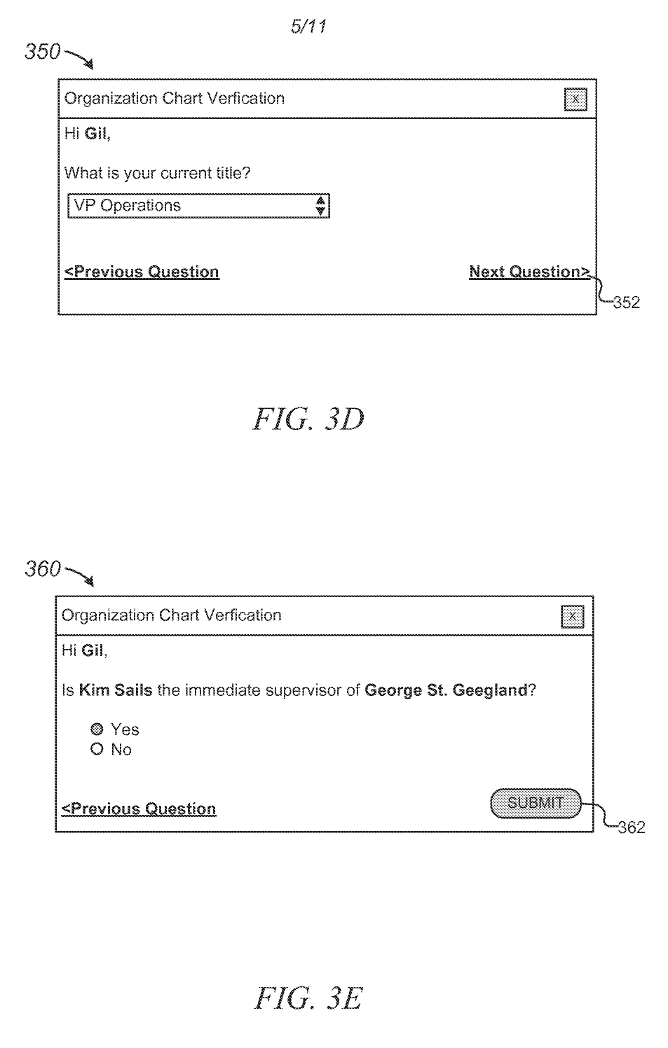

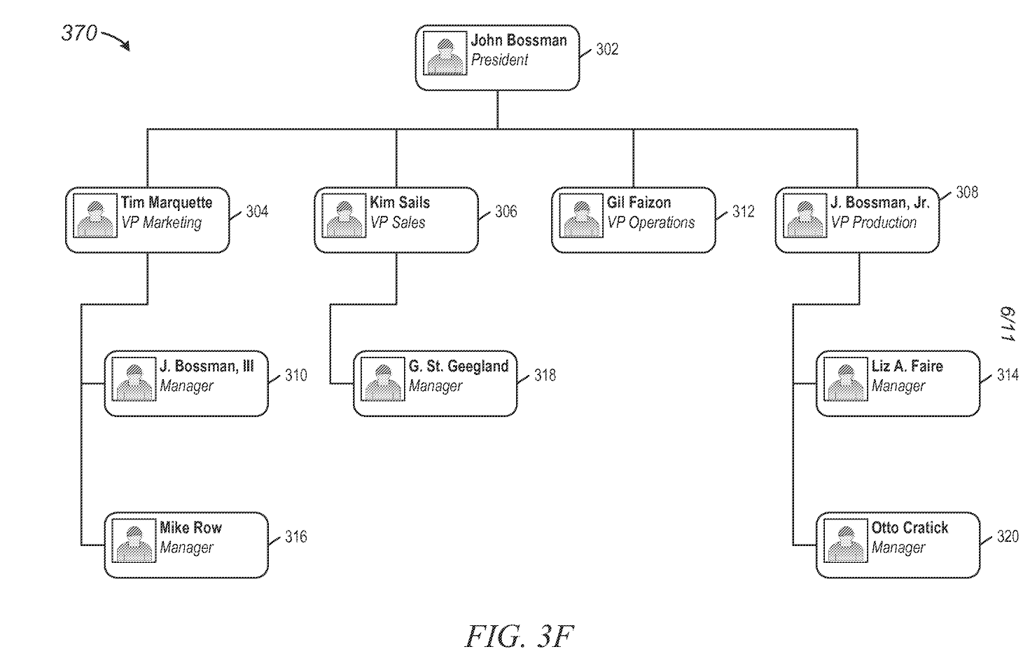

FIG. 3A is a block diagram illustrating an organization chart 300, according to an example embodiment. The organization chart 300 illustrated in FIG. 3A may correspond to an organization chart generated by the organization chart generation engine 108, or an organization chart generated by a third party service and retrieved from the third party server 118. The organization chart 300 illustrates the hierarchy of an organization comprised of users 302-320, who are also users of the social network service 102. As shown, the organization chart specifies a name and a title for each of the users 302-320. It shall be appreciated that in other embodiments, the organization may include additional or alternative information about the users 302-320 such as an organization identifier, years of service in the organization, employee ID numbers, or any other information commonly included in an organization chart.

In addition to identifying the users 302-320 comprising the organization, the organization chart 300 also illustrates the relationships of the users 302-320, which provide the structure of the organization. As used herein, the term “relationship,” when used with respect to an organization or organization chart, may refer to either a supervisory relationship (e.g., a person who supervises or is responsible for another) or a subordinate relationship a person who is lower in rank or under the authority of a supervisor). For example, as shown in the organization chart 300, the user 302 is the supervisor to users 304-308. In turn, the users 304-308 may also be referred to as the subordinates of the user 302. Similarly, the user 304 is shown to be the supervisor of users 310 and 316; the user 306 is shown to be the supervisor of users 312 and 318; and the user 308 is shown to be the supervisor of users 314 and 320. As such, the users 310-320 may be referred to as the subordinates of users 304-308, respectively.

FIG. 3B is an interface diagram illustrating a window 330 prompting the user 312 for organization chart verification information, according to an example embodiment. The window 330 may be presented to the user 312 based on the user 312 being included in the organization chart 300, and in particular, being included in a portion of the organization chart 300 which is being verified. As shown, the window 330 includes a request that the user 312 verify that the user 306 is his supervisor. As shown, the user 312 has specified that the user 306 is not his supervisor. Thus, the user 312 has provided contradictory verification information that differs from the information presented in the organization chart 300. Upon selection of a user interface element 332 presented in the window 330, the verification information entered by the user in the window 330 (e.g., that the user 306 is not the supervisor of the user 312) may be received by the social network service 102. In some instances, the user 312 may also be presented with an additional window requesting additional verification information.

For example, FIG. 3C is a interface diagram illustrating another window 340 prompting the user 312 for additional organization chart verification information, according to an example embodiment. As shown, the window 340 includes a request that the user 312 identify his supervisor due to the user 312 having previously contradicted the information in the organization chart 300 regarding the supervisor of the user 312. The window 340 may provide a drop down menu or other suitable interface element for inputting an identifier or a user (e.g., a name or email address). As shown, the user 312 has specified the user 302 (e.g., “John Bossman”) as his supervisor. Upon selection of a user interface element 342 presented in the window 340, the verification information entered by the user in the window 340 (e.g., that the user 302 is the supervisor of the user 312) may be received by the social network service 102. In some instances, the user 312 may also be presented with an additional window requesting additional verification information.

FIG. 3D is an interface diagram illustrating yet another window 350 prompting the user 312 for additional organization chart verification information, according to an example embodiment. As shown, the window 350 includes a request for the user 312 to provide his title. The window 350 may provide a drop down menu or other suitable interface element for inputting a title. As shown, the user 312 has specified his title as “VP Operations.” Upon selection of a user interface element 352 presented in the window 350, the verification information entered by the user in the window 350 (e.g., that “VP Operations” is the title of the user 312) may be received by the social network service 102. In some instances, the user 312 may also be presented with an additional window requesting additional verification information.

FIG. 3E is an interface diagram illustrating still another window 360 prompting the user 312 for additional organization chart verification information, according to an example embodiment. As shown, the window 360 includes a request that the user 312 verify that the user 306 is the immediate supervisor of the user 318. As shown, the user 312 has specified that the user 306 is the supervisor of the user 318, which confirms the information contained in the organization chart 300. Upon selection of a user interface element 362 presented in the window 360, the verification information entered by the user in the window 360 (e.g., that the user 306 is the supervisor of the user 318) may be received by the social network service 102. Upon receipt of such confirmation, the update module 202 may update an accuracy indicator for the portion of the organization chart data representing the relationship and relative rank of the user 306 and the user 312 to reflect the confirmation of the accuracy of the data.

FIG. 3F is a block diagram illustrating an updated organization chart 370 based on the verification information received from the user 312, according to an example embodiment. More specifically, the updated organization chart 370 is an updated version of the organization chart 300 updated based on the verification information entered into the windows 330, 340, 350, and 360 by the user 312. In particular, the organization chart 300 has been updated to reflect that the user 306 is not the supervisor of the user 312. The updated organization chart 370 instead shows that the user 312 is actually the direct subordinate of the user 302. The updated organization chart 370 is further shown to include the updated title of the user 312 provided by the user 312 in the window 350.

FIG. 4 is a flowchart illustrating a method 400 for generating an organization chart based on social data, according to an example embodiment. The method 400 may be embodied in computer-readable instructions for execution by one or more processors such that the method 400 may be carried out in whole or in part by the social network service 102. In particular, the method 400 may be carried out by the organization chart generation engine 108, and accordingly, the method 400 is described below by way of example with reference thereto. However, it shall be appreciated that the method 400 may be deployed on various other hardware configurations and is not intended to be limited to the organization chart generation engine 108.

At operation 402, the organization chart generation engine 108 may identify a group of users belonging to a common organization (e.g., a company) as defined by a social graph (e.g., stored in database 114) maintained by the social network service 102. At operation 404, the organization chart generation engine 108 may access social data (e.g., member profile data, social graph data, and behaviour data) about each user of the group of users. The social data may, for example, include relationships of the group of the users. Consistent with some embodiments, the social data may further include interactions of the group of users facilitated by the social network service 102.

At operation 406, the organization chart generation engine 108 may predict an organization chart for the group of users based on the social data. The predicted organization chart defines a hierarchy of the organization including the structure of the organization and the relative ranks of each of its members. In some instances, the organization chart generation engine 108 may predict at least a portion of the organization chart based on interactions among the members of the group of users. In particular, the organization chart generation engine 108 may determine a relationship between and relative ranks of users based on a frequency of interaction, an amount of interaction, or a number of users involved in a given interaction. For example, the organization chart generation engine 108 may determine that a first user is a supervisor of a group of five other users based on the first user frequently publishing messages directed at the five other users.

At operation 408, the organization chart generation engine 108 may store data (e.g., organization chart data) representing the organization chart (e.g., determined at operation 406). The organization chart data may be stored in a database of the social network service 102 (e.g., databases 112, 114 and 116).

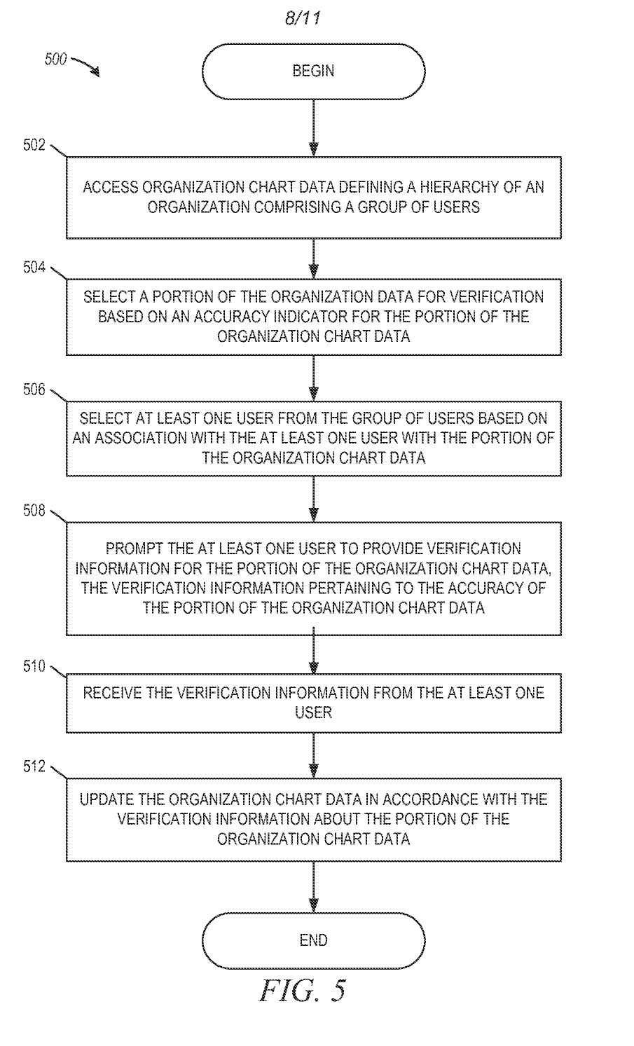

FIG. 5 is a flowchart illustrating a method 500 for updating organization chart data based on information received from a user who is included in the organization chart, according to an example embodiment. The method 500 may be embodied in computer-readable instructions for execution by one or more processors such that the method 500 may be carried out in whole or in part by the social network service 102. In particular, the method 500 may carried out by the modules comprising the organization chart maintenance application 110, and accordingly, the method 500 is described below by way of example with reference thereto. However, it shall be appreciated that the method 500 may be deployed on various other hardware configurations and is not intended to be limited to the modules forming the organization chart maintenance application 110.

The method 500 may be triggered by a user request, or may be performed routinely. At operation 502, the analysis module 200 may access organization chart data defining a hierarchy of an organization comprising a group of users. Consistent with some embodiments, the organization chart represented by the organization chart data may include users of the social network service 102 as well as individuals who are not users of the social network service 102.

At operation 504, the analysis module 200 may select a portion of the organization chart data for verification based on an accuracy indicator for the portion of the organization chart data. Consistent with some embodiments, an accuracy indicator may be maintained for each portion of the organization chart data. The accuracy indicator indicates a level of accuracy for the portion of the organization chart data. The level of accuracy provided by each accuracy indicator may be based on changes to member profile data of users in an organization chart (e.g., title or position change, or a change in listed employer), contradictory information about organization chart data received from users included in the organization chart, staleness of member data of users in the organization chart (e.g., an amount of time passed since data was last updated), or staleness of the organization chart data. In an illustrative example of operation 504, the analysis module 200 may select a portion of the organization chart data representing a supervisory relationship of a first user with a second user based on a change to the title of the second user as reflected by the member data of the second user.

At operation 506, the analysis module 200 may select at least one user (e.g., of the social network service 102) from the group of users based on an association with the portion of the organization chart data. The user(s) selected by the analysis module 200 will be prompted, in subsequent operations, for information pertaining to the accuracy of the portion of the organization chart data. In this manner, the organization chart maintenance application 110 may leverage information from the users likely to have the most knowledge of the structure, relationships, and ranks represented by the portion of the organization chart data. Following the example presented above, the analysis module 200 may select the first and second users based on the relationship and relative rank of the first and second users being represented by the portion of organization chart data.

At operation 508, the user interface module(s) 104 may prompt the at least one user (selected at operation 506) to provide verification information for the portion of the organization chart data. The verification information requested from the at least one user pertains to the accuracy of the portion of the organization chart data. In prompting the at least one user to provide the verification information, the user interface module(s) 104 may utilize any number of message delivery networks and platforms to deliver messages to users. For example, the user interface module(s) 104 may prompt the at least one user by displaying a window embedded in or overlaid upon a web page provided by the social network service 102, transmitting an email to the at least one user, transmitting an instant message (IM) to the at least one user, using a messaging service provided by the social networking service 102, or transmitting a text or short message service (SMS) message to a registered device of the at least one user.

Consistent with some embodiments, the prompting the at least one user to provide verification information includes asking the at least one user to provide an answer to one or more questions regarding the information in the organization chart. Depending on the question, the user interface module(s) 104 may provide the at least one user with a variety of mechanisms for responding to questions including, for example, selectable drop-down menus, check boxes or selectable bubbles, or text entry fields. At operation 510, the user interface module(s) 104 may receive the verification information from the at least one user.

At operation 512, the update module 202 may update the organization chart data in accordance with the verification information about the portion of the organization chart data. In some instances, the updating of the organization chart data may comprise modifying the organization chart data to reflect an updated organization structure, relationship or user rank (e.g., title), as well as updating an accuracy indicator for the portion of the organization chart data. In other instances, the updating of the organization chart data may comprise simply updating the accuracy indicator for the portion of the organization chart data.

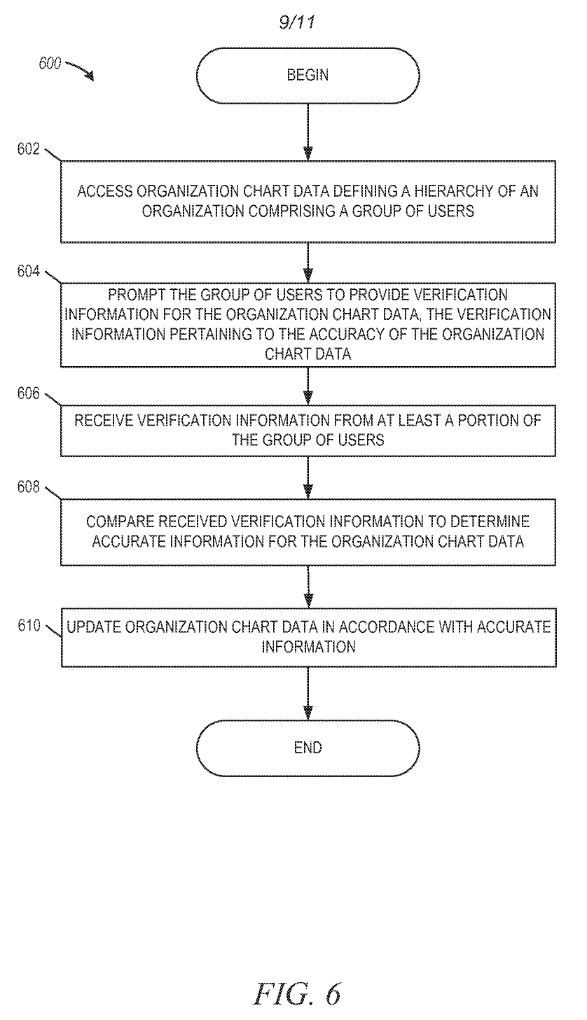

FIG. 6 is a flowchart illustrating a method 600 for updating organization chart data based on information received from a group of users included in the organization chart, according to an example embodiment. The method 600 may be embodied in computer-readable instructions for execution by one or more processors such that the method 600 may be carried out in whole or in part by the social network service 102. In particular, the method 600 may be carried out by the modules comprising the organization chart maintenance application 110, and accordingly, the method 600 is described below by way of example with reference thereto. However, it shall be appreciated that the method 600 may be deployed on various other hardware configurations and is not intended to be limited to the modules forming the organization chart maintenance application 110.

At operation 602, the analysis module 200 may access organization chart data defining a hierarchy of an organization comprising a group of users. Consistent with some embodiments, the organization chart represented by the organization chart data may include users of the social network service 102 as well as individuals who are not users of the social network service 102.

At operation 604, the user interface module(s) 104 may prompt the group of users to provide verification information for the organization chart data. The verification information requested from the group of users pertains to the accuracy of the organization chart data. Each user of the group of users may be prompted concurrently, or within a certain time period. In prompting the group of users to provide the verification information, the user interface module(s) 104 may utilize any number of message delivery networks and platforms to deliver messages to users. For example, the user interface module(s) 104 may prompt each user of the group of users by displaying a window embedded in or overlaid upon a web page provided by the social network service 102, transmitting an email, transmitting an instant message (IM) using a messaging service provided by the social networking service 102, or transmitting a text or short message service (SMS) message.

Consistent with some embodiments, the prompting of the group of users may include asking each user of the group of users to provide an answer to one or more questions regarding the information in the organization chart. Depending on the question, the user interface module(s) 104 may provide each user with a variety of mechanisms for responding to questions, including, for example, selectable drop-down menus, check boxes or selectable bubbles, or text entry fields. At operation 606, the user interface module(s) 104 may receive the verification information from at least a portion of the group of users.

At operation 608, the analysis module 200 may compare verification information received from each of the users to determine accurate information for the organization chart. The determination of accurate information for the organization chart may include identifying the verification information with the greatest consensus (e.g., the information that the majority of responding users agree on) as the accurate information.

At operation 610, the organization chart data is updated in accordance with the accurate information. The updating of the organization chart data may include updating an accuracy indicator, and in some embodiments, updating the organization chart data to reflect a change in the structure of the organization, in a particular relationship, or in a particular rank.

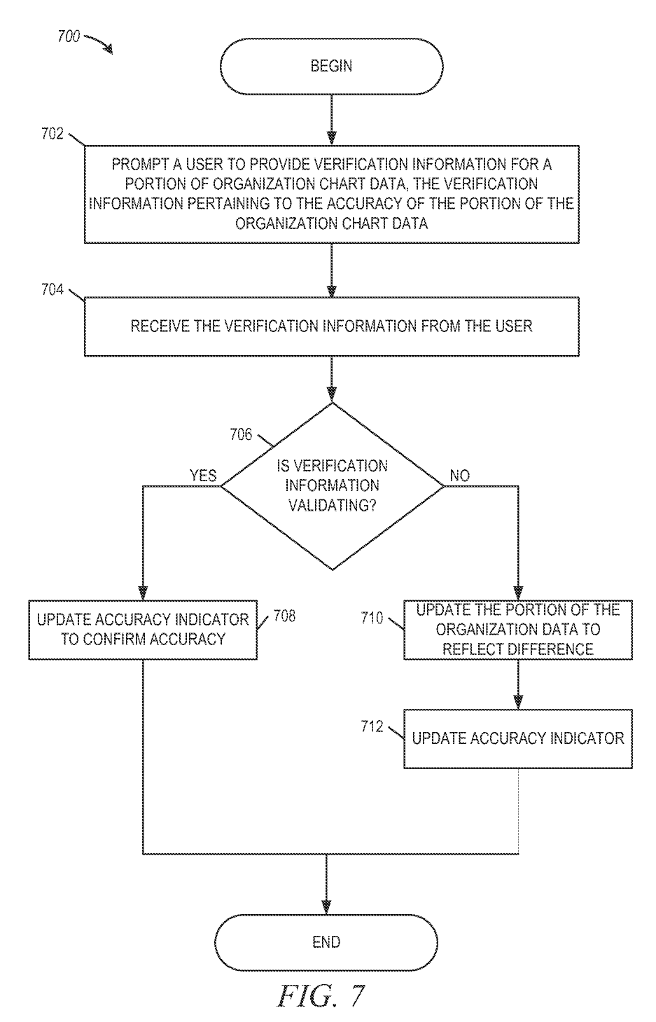

FIG. 7 is a flowchart illustrating a method 700 for tracking accuracy of organization chart data, according to an example embodiment. The method 700 may be embodied in computer-readable instructions for execution by one or more processors such that the method 700 may be carried out in whole or in part by the social network service 102. In particular, the method 700 may be carried out by the modules comprising the organization chart maintenance application 110, and accordingly, the method 700 is described below by way of example with reference thereto. However, it shall be appreciated that the method 700 may be deployed on various other hardware configurations and is not intended to be limited to the modules forming the organization chart maintenance application 110.

At operation 702, the user interface module(s) 104 may prompt a user to provide verification information for the portion of the organization chart data. The verification information requested from the user pertains to the accuracy of the portion of the organization chart data. In prompting the user to provide the verification information the user interface module(s) 104 may utilize any number of message delivery networks and platforms to deliver messages to users. For example, the user interface module(s) 104 may prompt the user by displaying a window embedded in or overlaid upon a web page provided by the social network service 102, transmitting an email to the at least one user, transmitting an instant message (IM) to the user using a messaging service provided by the social networking service 102, or transmitting a text or short message service (SMS) message to a registered device of the user.

Consistent with some embodiments, the prompting the user to provide verification information includes asking the user to provide an answer to one or more questions regarding the information in the organization chart. Depending on the question, the user interface module(s) 104 may provide the user with a variety of mechanisms for responding to questions, including, for example, selectable drop-down menus, check boxes or selectable bubbles, or text entry fields. At operation 704, the user interface module(s) 104 may receive the verification information from the user.

At decision block 706, the analysis module 200 may determine Whether the verification information provided by the user validates the accuracy of the portion of the organization chart data. The determining of whether the verification information validates the accuracy of the portion of the verification information may include comparing the verification information with the information in the organization chart data to determine if there is a difference, consistent with some embodiments. The determining of whether the verification information validates the accuracy of the portion of the verification information may further include comparing the verification information received from the user with other verification information about the portion of the organization chart data received from other users. For example, the analysis module 200 may determine that verification information received from the user is validating based on the information being in agreement with all other received verification information.

If the analysis module 202 determines that the verification information validates the accuracy of the organization chart data (e.g., the verification information is the same as the information in the organization chart data), the update module 202 may update the accuracy indicator to confirm such accuracy, at operation 708. The updating of the accuracy indicator may include updating a flag, which indicates that the data is either “accurate” or “inaccurate,” or increasing a level (e.g., a percentage) of accuracy represented by the accuracy indicator.

If the analysis module 200 determines that the verification information contradicts the accuracy of the organization chart data (e.g., the verification information is different from the information in the organization chart data), the update module 202, may update the portion of the organization data to reflect an updated or changed structure, relationship, and/or rank, at operation 710. At operation 712, the update module 202 may update the accuracy indicator in light of the updated organization chart data. The updating of the accuracy indicator may include updating a flag, which indicates that the data is either “accurate” or “inaccurate,” or increasing or decreasing a level (e.g., a percentage) of accuracy represented by the accuracy indicator.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, in computer hardware, firmware, or software, or in combinations of these. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry′, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

FIG. 8 is a block diagram of machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (CPU) or both), a main memory 804 and a static memory 806, which communicate with each other via a bus 808. The computer system 800 may further include a video display 810 (e.g., a liquid crystal display (LCD) or a cathode ray tube (CRT)). The computer system 800 may also include an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions (e.g., the instructions 824) for execution by the computer system 800 and that cause the computer system 800 to perform any one or more of the methodologies of the present inventive subject matter, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing organization chart data defining a hierarchy of an organization comprising a group of users;
prompting at least one user of the group of users to provide verification information for a portion of the organization chart data, the verification information pertaining to accuracy of the portion of the organization chart data;
receiving the verification information from the at least one user of the group of users; and
updating, using one or more processors, the organization chart data in accordance with the verification information.

2. The method of claim 1, further comprising selecting the portion of the organization chart data for verification based on an accuracy indicator for the portion of the organization chart data.

3. The method of claim 2, wherein accuracy indicator is based on an amount of time passed since an update to the portion of the organization chart data occurred.

4. The method of claim 2, wherein the accuracy indicator is based on a change to social data about one user of the group of users.

5. The method of claim 1, wherein the verification information contradicts information included in the portion of the organization chart data, and wherein the updating of the organization chart data includes modifying the organization chart data in accordance with the verification information.

6. The method of claim 1, further comprising providing the at least one user with a reward in response receiving the verification information from the at least one user.

7. The method of claim 6, wherein a value of the reward is based on a predetermined number of users from the group of users providing verification information similar to the verification information provided by the at least one user.

8. The method of claim 1, further comprising:
accessing social data about the group of users, the social data including relationships of the group of users;
determining an organization chart for the group of users based on the social data; and
storing the organization chart data representing the organization chart.

9. The method of claim 8, wherein the social data further includes interactions of the group of users using a social network service, and wherein the determining the organization chart is based on the interactions.

10. The method of claim 1, wherein the updating of the organization chart data includes updating an accuracy indicator for the portion of the organization chart data.

11. A machine-readable storage medium having no transitory signals and embodying instructions that, when executed by a machine, cause the machine to perform operations comprising:
accessing organization chart data defining a hierarchy of an organization comprising a group of users;
prompting at least one user of the group of users to provide verification information for a portion of the organization chart data, the verification information pertaining to accuracy of the portion of the organization chart data;
receiving the verification information from the at least one user of the group of users; and
updating the organization chart data in accordance with the verification information.

12. The machine-readable storage medium of claim 11, further embodying instructions that cause the machine to perform operations comprising:
selecting the portion of the organization chart data for verification based on an accuracy indicator for the portion of the organization chart data; and
selecting the at least one user from the group of users based on an association with the portion of the organization chart data.

13. The machine-readable storage medium of claim 12, wherein the accuracy indicator is based on information, previously received from other users in the group of users, regarding accuracy of the portion of the organization chart data.

14. The machine-readable storage medium of claim 11, wherein the received verification information confirms accuracy of the portion of the organization chart data, and wherein the updating of the organization chart data comprises updating an accuracy indicator for the portion of the organization chart data to reflect the confirmed accuracy.

15. The machine-readable storage medium of claim 11, wherein the verification information contradicts information included in the portion of the organization chart data, and wherein the updating of the organization chart data includes modifying the organization chart data in accordance with the verification information.

16. The machine-readable storage medium of claim 11, further comprising providing the at least one user with a reward in response to receiving the verification information from the at least one user.

17. The machine-readable storage medium of claim 11, further embodying instructions that cause the machine to perform operations comprising:
accessing social data about the group of users, the social data including relationships of the group users;
determining an organization chart for the group of users based on the social data; and
storing the organization chart data representing the organization chart.

18. The machine-readable storage medium of claim 17, wherein the social data further includes interactions of the group of users using a social network service.

19. The machine-readable storage medium of claim 17, wherein the determining an organization chart for the group of users is based in part on a frequency of interaction between the group of users.

20. A system comprising:
a processor of a machine;
an analysis module to access organization chart data defining a hierarchy of an organization comprising a group of users;
a user interface module to prompt at least one user of the group of users to provide verification information for a portion of the organization chart data, the verification information pertaining to accuracy of the portion of the organization chart data, the user interface module further to receive the verification information from the at least one user of the group of users; and
an update module to update the organization chart data in accordance with the verification information.
